(19) United States
(12) Patent Application Publication
(10) Pub. No.: US 2017/0268912 A1
(43) Pub. Date: Sep. 21, 2017

(54) SYSTEM AND METHOD FOR CONTROLLING SENSOR DATA GENERATION

(71) Applicant: Centre de recherche industrielle du Québec, Quebec (CA)

(72) Inventor: Hubert Talbot, Montmagny (CA)

(73) Assignee: Centre de recherche industrielle du Québec, Quebec (CA)

(21) Appl. No.: 15/074,486

(22) Filed: Mar. 18, 2016

(51) Int. Cl. G01D 13/00; G01B 11/14; H04L 29/08

(52) U.S. Cl. CPC G01D 13/00; H04L 67/12; G01B 11/14

(57) ABSTRACT

A system for controlling generation of data by a plurality of sensor units, each being located at a known distance from a reference position on a travel path of a moving object having a target area to be scanned, makes use of a data communication network linked to the sensor units, a trigger module configured to generate a sensor triggering signal specific to each sensor unit, and a controller module configured for assembling the sensor output data generated by the sensor units and associated with the object target area. The trigger module is configured for calculating, from the speed or position profile of the moving object, a displacement of the object target area relative to the reference position, to generate a sensor triggering signal specific to each sensor unit as soon as the displacement corresponds to the associated sensor unit distance, the sensor triggering signal causing the sensor unit to generate output data.

### TECHNICAL FIELD

The present invention relates to the field of measuring instrumentation and more particularly to systems and methods for controlling sensor data generation in applications involving various sensors having their sensing fields being successively traversed by a moving object under inspection.

### BACKGROUND OF THE ART

In many measuring applications performed on objects of various kinds, such as raw materials and components feeding industrial production processes or products resulting therefrom, the detection of object characteristics may often involve the use of several sensors of different types, whose outputs are combined for the desired purpose. For example, in the context of many industrial applications requiring process control, the variations of raw material properties such as color, volume, weight, density and moisture content are important parameters to measure online. Commercial sensors to measure material properties have been available for industrial process online measurement for more than 40 years. Measurement techniques based on electrical or electromagnetic principles such as microwave, capacitance, conductivity, radio frequency and NIR (Near Infrared), have been applied for moisture content and other physical property measurements. For example, a known technique for estimating surface moisture content of wood chips as disclosed in U.S. Pat. No. 7,292,949 involves a surface moisture measurement obtained from a non-contact surface moisture sensor such as NIR-based moisture sensor, which measurement is calibrated with values of a set of optical parameters, such as HSL color camera signals, representing light reflection characteristics of the wood chips, in order to estimate the surface moisture content thereof. In many cases, it is required to perform properties measurements relative to a target area on the object moving along a travel path, e.g. as transported on a conveyor, using various sensors located along the travel path in a spaced apart relationship. A know approach to allow accurate assembling of the sensor data coming from the various sensors, which task of assembling is also known as “synchronization”, consists of directly connecting each sensor to a displacement encoder linked to the conveyor. Knowing the spacing between the sensors, the sensor data relative to a same target area on the inspected material or object can be readily obtained. A similar approach is disclosed in U.S. Pat. No. 5,960,104 to Conners et al. which uses a servo motor to control the speed at which an object under inspection pass through the measurement system. However, the complexity and cost of such approach increase with the number of sensors involved. Another approach as disclosed in U.S. Pat. No. 8,193,481 makes use of a reference time data that is compared with local time data generated by a sensor local clock when the reference time data is received, causing a local clock update. Then, the sensor output data is assembled with the corresponding sensed location data according to an associated updated time data. While representing an improvement over the conventional encoder-based approach, the accuracy of data assembling provided by such time data-based approach requires availability of a highly stable reference time data source.

### SUMMARY OF THE INVENTION

It is an object of the present invention to provide a system for controlling generation of data by a plurality of sensor units, the data being related to a target area on an object moving at a known speed or position profile along a travel path intersecting a sensing field associated with each sensor unit located at a known distance from a reference position on the travel path, comprising: a data communication network linked to the sensor units; a trigger module linked to the communication network and configured for calculating from the speed or position profile a displacement of the object target area relative to the reference position, to generate a sensor triggering signal specific to each sensor unit as soon as the displacement corresponds to the associated sensor unit distance, the sensor triggering signal causing the sensor unit to generate output data; and a controller module linked to the communication network and configured for assembling the sensor output data generated by the sensor units and associated with the object target area.

It is another object of the present invention to provide a method for controlling generation of data by a plurality of sensor units, the data being related to a target area on an object moving at a known speed or position profile along a travel path intersecting a sensing field associated with each sensor unit being located at a known distance from a reference position on the travel path, comprising the steps of: i) calculating from the speed or position profile a displacement of the object target area relative to the reference position, and generating from the calculated displacement a sensor triggering signal specific to each sensor unit as soon as the displacement corresponds to the associated sensor unit distance, the sensor triggering signal causing the sensor unit to generate output data; and ii) assembling the sensor output data generated by the sensor units and associated with the object target area.

It is another object of the present invention to provide a non-transitory software product data recording medium in which program code is stored causing a computer to perform method steps for controlling generation of data by a plurality of sensor units, the data being related to a target area on an object moving at a known speed or position profile along a travel path intersecting a sensing field associated with each sensor unit located at a known distance from a reference position on the travel path, the method steps comprising: i) calculating from the speed or position profile a displacement of the object target area relative to the reference position, and generating from said calculated displacement a sensor triggering signal specific to each sensor unit as soon as the displacement correspond to the associated sensor unit distance, the sensor triggering signal causing the sensor unit to generate output data; and ii) assembling the sensor output data generated by the sensor units and associated with the object target area.

### BRIEF DESCRIPTION OF THE DRAWINGS

Various embodiments of systems and methods according to the present invention will now be described in detail with reference to the accompanying drawings in which:

FIG. 1 is a general schematic view of a measurement station that can be used with the present invention;

FIG. 2 is a schematic elevation view of a basic measuring station including two sensor units;

FIG. 3 is a general block diagram of a proposed control system architecture;

FIG. 4 is a detailed block diagram of a proposed configuration for the sensor host program used in an embodiment of control system architecture of FIG. 3;

FIG. 5 a detailed block diagram of a proposed configuration for the trigger module used in an embodiment of control system architecture of FIG. 3;

FIG. 6 is a detailed block diagram of a proposed configuration for the controller module used in an embodiment of control system architecture of FIG. 3;

FIG. 7 is a diagram presenting an example of progressive displacement with time of object portions as they successively intersects the sensing fields of a plurality of sensor units disposed in spaced apart relationship along the object travel path;

FIG. 8 is an example of displayed screenshot generated by an operator interface linked to the controller module of FIG. 3 as the measurement system of FIG. 1 is performing sensor data generation in a discrete mode of operation; and

FIG. 9 is an example of displayed screenshot generated by an operator interface linked to the controller module of FIG. 3 as the measurement system of FIG. 1 is performing sensor data generation in a continuous mode of operation.

The above summary of the invention has outlined rather broadly the features of the present invention. Additional features and advantages of some embodiments illustrating the subject of the appended claims will be described hereinafter. Those skilled in the art will appreciate that they may readily use the description of the specific embodiments disclosed as a basis for modifying them or designing other equivalent structures or steps for carrying out the same purposes of the present invention. Those skilled in the art will also appreciated that such equivalent structures or steps do not depart from the scope of the present invention in its broadest form.

### DETAILED DESCRIPTION OF EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are illustrated by schematic representations using graphic symbols, wherein details which are not necessary for an understanding of the present invention or which render other details difficult to perceive may have been omitted.

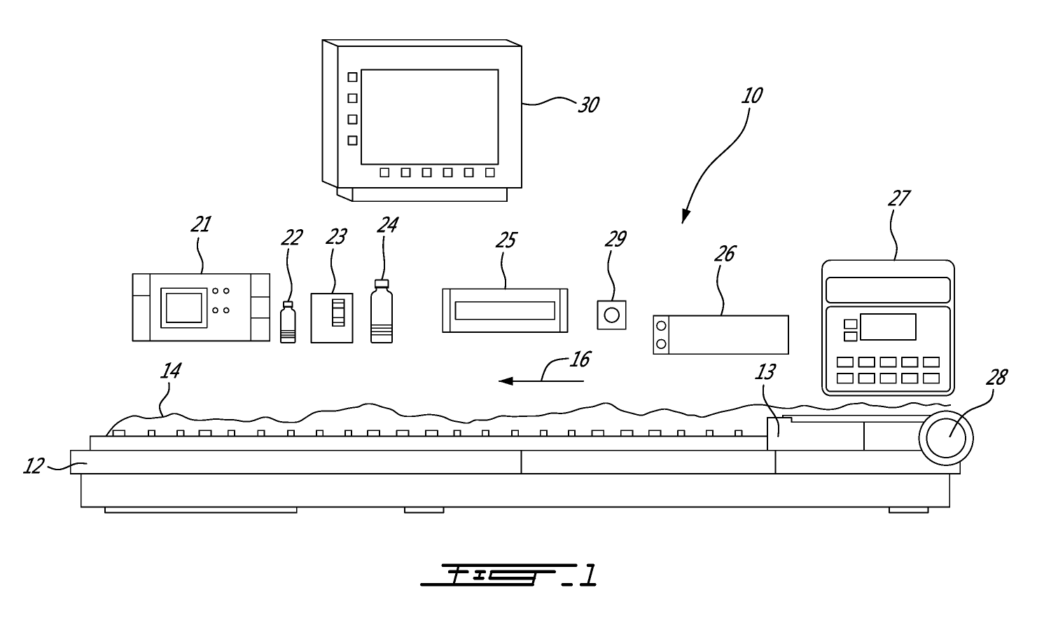

Referring now to FIG. 1, there is shown a schematic representation of a measurement station that can be used with the present invention, which station generally designated at 10 includes a plurality of sensor units disposed in a spaced-apart relationship along a conveyor 12 transporting an object 14 to be inspected along arrow 16. Given the wide range of applications of the present invention, the term “object” is intended to have a broad spectrum of meanings, to designate things of various kinds and forms (e.g. individualized or in bulk form) that are caused to be moved and whose characteristics can being sensed, such as raw materials and components feeding industrial production processes or products resulting therefrom. According to the example shown in FIG. 1, the station includes a near-infrared (NIR) sensor 21 (e.g. used for humidity measurement) such as model CHI-IRMA-5184S from Chino (CA, USA) an infrared temperature sensor 22 such as model RAYM1310LTS from Raytec (CA, USA) and, a laser distance sensor 23 (e.g. used for volume measurement, intensity calibration of spectrometer or color camera), such as model SA1D-Lk4-240 VDC from Idec (Ontario, Canada). The station also includes an ultrasonic distance sensor 24 (e.g. used instead of laser sensor for highly reflective material such as metallic particles) such as model 943-F4Y-2D-1C0-180E from Honeywell (MN, USA), a visible spectrometer 25 (e.g. used for calibrating humidity measurement) such as model USB4000 from OceanOptics (FL, USA), a laser profilometer 26 (e.g. used for texture, grain size or volume measurement) such as model RulerE1212 from Sick (Ontario, Canada), a weigh sensor 27 making use of one or more load cells mechanically coupled to a section 13 of conveyor 12, such as model WL-24-0500 from Avery Weigh-Tronix (Quebec, Canada), a rotary encoder 28 such as model 8807-3107-0500 from Hohner (Ontario, Canada), and a color detector 29 such as model CV-M9GE from Jai (CA, USA). Interconnected with the measurement station 10 is a computer 30, such as model P1177E-871 from Axiomtek (Taiwan), which computer 30 is programmed to perform functions related to the control of sensor data generation, as will be described below in detail. Optionally, environmental temperature and humidity sensors may be provided.

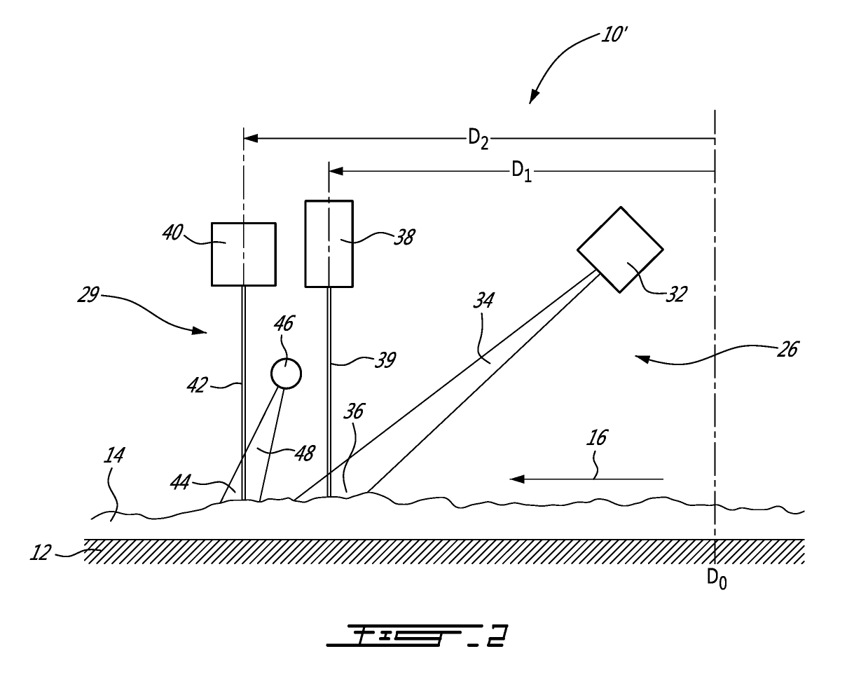

Referring to FIG. 2, a basic measurement station 10′ having two sensor units is schematically shown, which includes a first optical sensor unit used as a laser profilometer generally designated at 26 and provided with a first digital camera 32 having a first sensing field 34 defining a first scanning zone 36, to generate first sensor output data related to a first surface area on the inspected object 14 as scanned by a laser source 38 which directs a laser beam 39 toward first surface area on the object 14 while being moved in the direction of arrow 16. The station 10′ further includes a second optical sensor unit used as a color detector generally designated at 29 and provided with a second digital camera 40 having a second sensing field 42 defining a second scanning zone 44, to generate second sensor output data related to a second surface area on the moving object 14 as illuminated by a light source 46 emitting a light beam 48. It can be seen that the scanning zones 36 and 44 are respectively separated by known distances D₁ and D₂ to a reference position D₀, and the spacing between the sensors (D₂−D₁) is therefore also known. So as to ensure that all measurement data relative to a same target area on the inspected object can be obtained with accuracy, synchronisation is required.

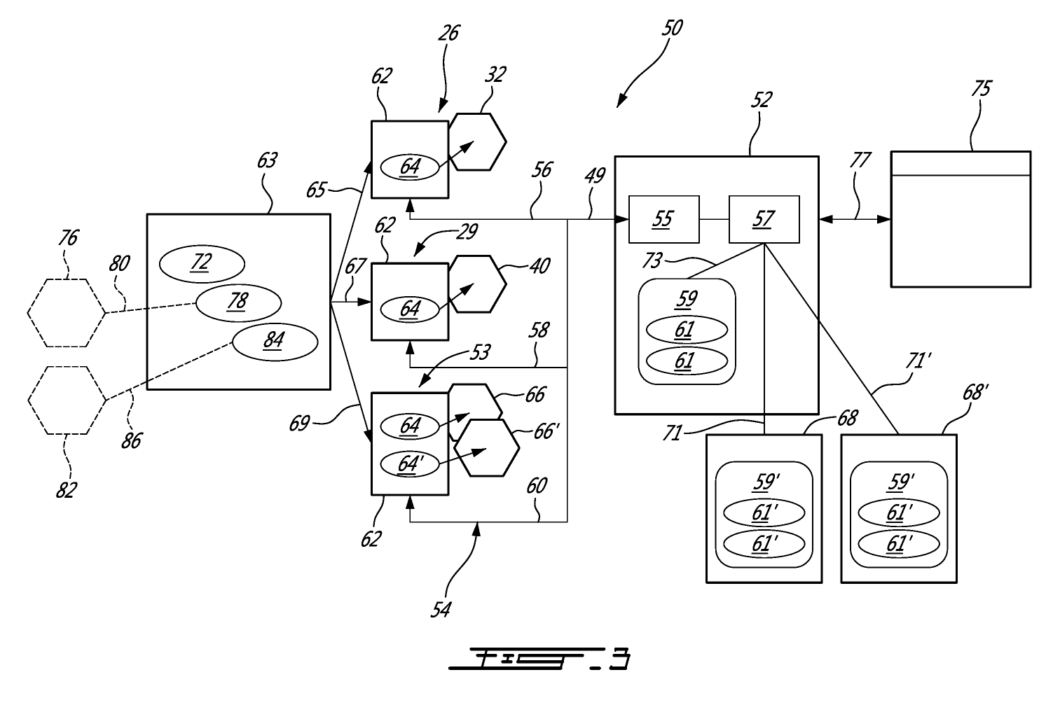

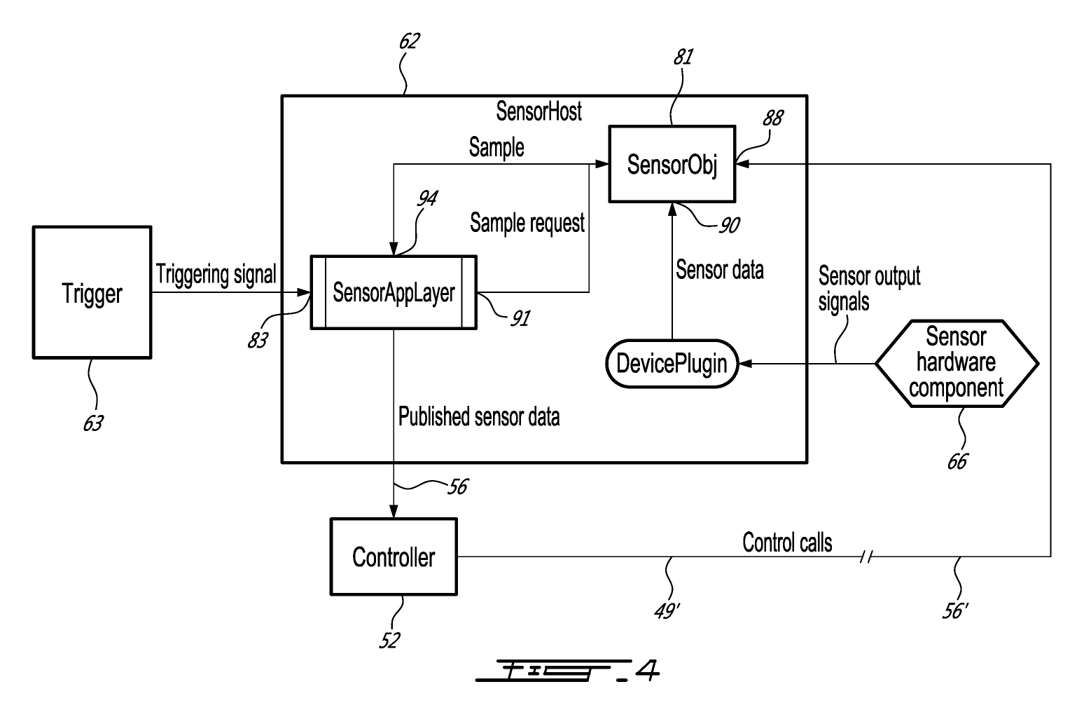

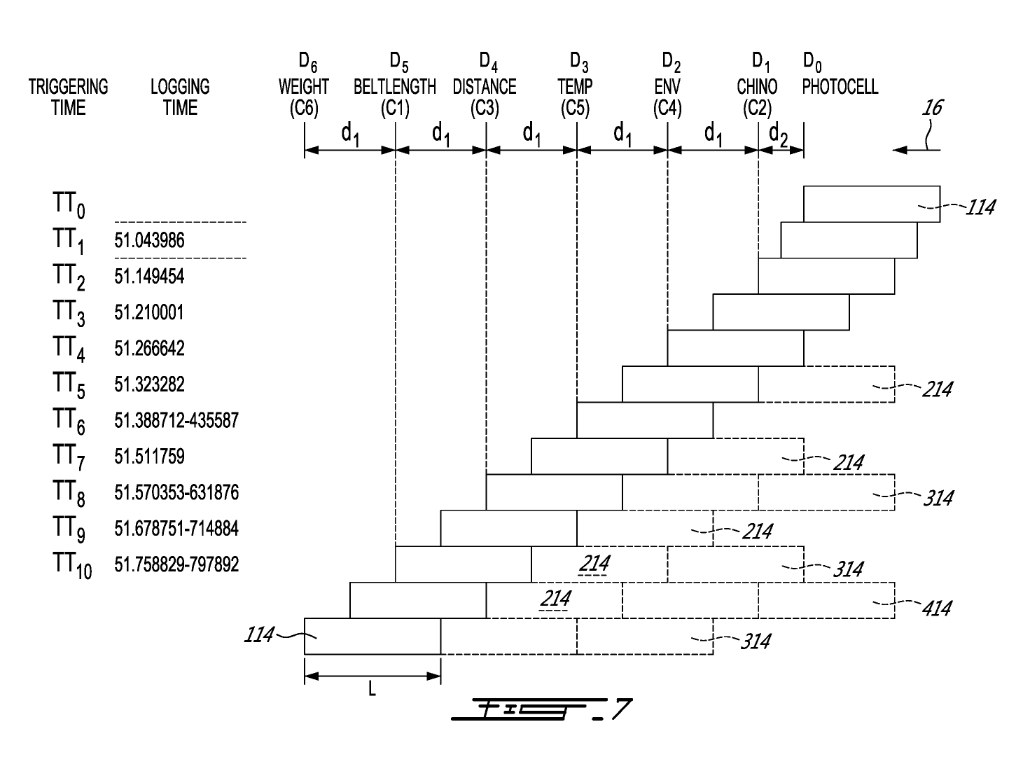

Referring to FIG. 3, there is shown a proposed architecture of an embodiment of system generally designated at 50 for controlling generation of data by a plurality of sensor units, generally designated at 26, 29 (same as shown in FIG. 2) and 53 (not shown in FIG. 2) in the present example, which data being related to a target area on the object 14 as shown in FIG. 2, moving at a known speed or position profile along a travel path parallel to arrow 16 intersecting a sensing field associated with each sensor unit 26, 29 and 53 being located at a known distance from a reference position Dₒ on the travel path, as will be explained below in more detail in view of FIG. 7. As shown in FIG. 3, the system 50 includes a data communication network generally designated at 54 and linked to the sensor units 26, 29 and 53 through data lines 56, 58 and 60. In the example shown, each sensor unit 26, 29, and 53 includes at least one hardware component respectively designated at 32, 40 (corresponding to first and second digital cameras of FIG. 2) and 66, which includes all mechanical, electrical, electronic or optical devices involved by the specific type of sensor used to obtain the desired measurement, as explained above in view of FIG. 1. In addition to their respective hardware components 32, 40 and 66, the sensor units 26, 29 and 53 each host an executable program 62 including a software component 64, such as of plugin type, configured to communicate with the hardware components, which executable program 62 and software component 64 are respectively named “SensorHost” and “DevicePlugin” in the detailed block diagram of FIG. 4. The functions of the program 62 are to receive triggering and sensor output signals, publish sensor data upon triggering, create objects (e.g. C++/Corba objects) that accepts control calls from a controller module 52, the function of which will be explained below in detail, and create the device plugin. The function of the software component 64 is to communicate with the associated hardware component through an appropriate application programming interface (API) depending on hardware used. To perform its functions, the program 62 also makes use of two linked software objects (e.g. programmed using C++/Corba), namely an application layer 79, designated as “SensorAppLayer” in the block diagram of FIG. 4, and a sensor data acquisition object 81, designated as “SensorObj”, the specific functions of which objects will be explained below in detail.

In an embodiment, a data communication network of a DDS (Data Distribution Service) standard may be used. Any other appropriate type of data communication network such as RTNet™ or EtherCat™ may be also used. In the example of FIG. 3, in addition to a first hardware component 66 associated with a first sensor included in the sensor unit 53, the latter further includes a second hardware component 66′ associated with a second sensor also being part of the sensor unit 53 and required to obtain the desired measurement. For example, in the context of the measurement system 10 described above in view of FIG. 1, the hardware components 66 and 66′ may correspond to a NIR sensor 21 combined with a weigh sensor 27, the outputs of which sensors being used to obtain dry density measurement. The second hardware component 66′ is in communication with the executable program 62 through software component 64′, in a same way as described above for software component 64 in view of f FIG. 4.

The system 50 further includes a trigger module 63 configured for calculating, from the object speed or position profile, a displacement of the object target area relative to the reference position D₀ shown in FIG. 2, to generate a sensor triggering signal through data lines 65, 67 and 69 as part of the data communication network 54, which signal specifically identifies each sensor unit 26, 29 and 53, as soon as the displacement corresponds to the associated sensor unit distance, which is D₁ for sensor unit 26 and D₂ for sensor unit 29 shown in FIG. 2. In an embodiment, the trigger module 63 is implemented as an executable program hosted by the computer 30 shown in FIG. 1. Although the computer 30 may conveniently be a general-purpose computer, an industrial computer or an embedded processing unit such as based on a digital signal processor (DSP) can also be used. It should be noted that the present invention is not limited to the use of any particular computer or processor for performing the processing tasks of the invention. Hence, the term “computer”, as that term is used herein, is intended to denote any machine capable of performing the calculations or computations, necessary to perform the tasks of the invention, and is further intended to denote any machine that is capable of accepting a structured input and of processing the input in accordance with prescribed rules to produce an output. It should also be noted that the phrase “configured to” or “configured for” as used regarding structures that are disclosed hereinafter, means that such structures are implemented in hardware, firmware, software or some combination of at least two of the same, and functions associated with such structures may be centralized or distributed, as will be understood by those skilled in the art.

Referring again to FIG. 3, the sensor triggering signal generated by the trigger module 63 causes the triggered sensor unit to generate output data through its associated data line 56, 58 or 60, in the form of a data sample as part of a sequence of data samples associated with each target area, wherein the number of data samples corresponds to the number of triggered sensor units. In an embodiment, the trigger module may be programmed by the user through an appropriate operator interface to select a subset of at least two of the sensor units included in the measurement station, so as to generate a sequence of data samples generated from the selected sensor units. In an embodiment, the sensor triggering signal is generated using the following data format:

data sample sequence identifier-sensor(s) identifier(s)-cumulative displacement from reference position Dₒ.

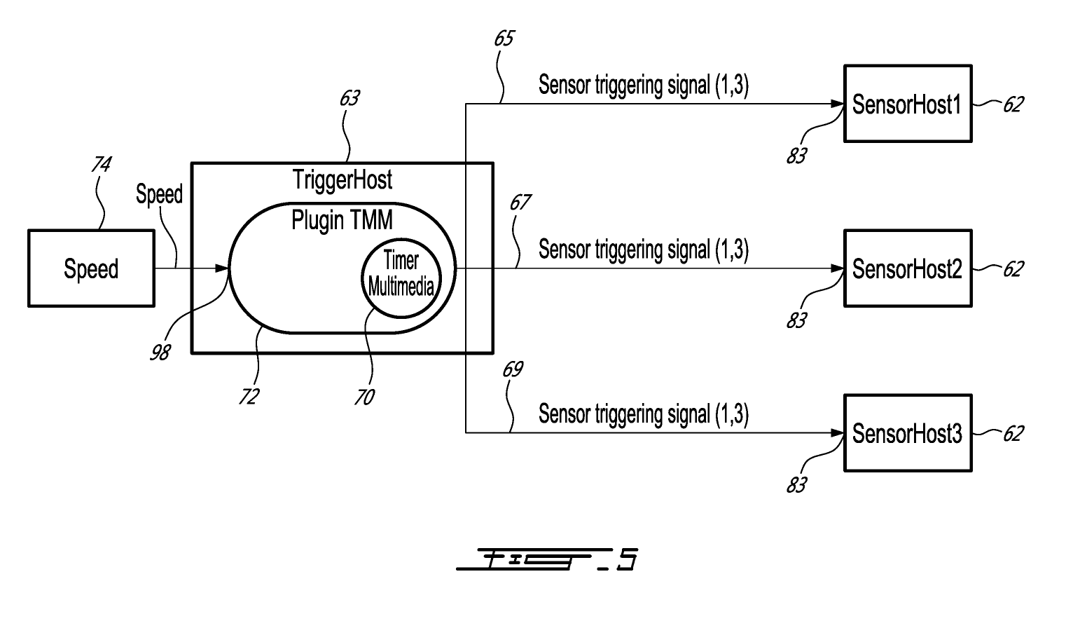

It is to be understood that, depending on sensor spacing, more than one sensor unit may be requested to generate a sample at a same triggering time, as will be explained below in view of the embodiment of FIG. 5 and further in view of FIG. 7 in the context of a practical example. Moreover, in cases where more than two sensor units are used, the spacing between a given pair of sensor units may be chosen to differ from another pair of sensor units, so that triggering signal generation may be performed accordingly, provided the spacing values are accurately known. In practice, with a DDS communication network, the latency for triggering signal generation is typically less than 100 μs, which is generally sufficient to provide acceptable accuracy even at high conveying speed. While in some cases the object speed or position profile may be substantially uniform, in many cases the object speed or position profile is caused to vary, which variation should be considered so as to obtain synchronization accuracy. Referring to FIG. 5 showing a block diagram of a proposed configuration for the trigger module 63 according to an embodiment of control system architecture, the displacement of the object target area relative to the reference position can be calculated from an instantaneous speed value represented at 74 combined with a software-generated timing data. For example, with a conveying speed of 2500 mm/s, the accuracy of displacement calculation would be 2.5 mm (D=V/T). In that embodiment, the trigger module designated as “TriggerHost” 63, configured to receive the speed value at input 98, includes a software component 72 such as of plugin type, which is configured to implement a timer module 70, such as a TMM (Timer Multi Media) provided on Windows™ operating system, capable of generating timing data in the form a corresponding signal typically of one pulse/ms accuracy, which pulse timing signal is used by the software component 72 to perform calculation of the displacement of the material of object target area relative to the reference position D₀. In FIG. 5, according to a chosen sensor spacing, the trigger module 63 is shown in an operating state where a sensor triggering signal, which identifies first and third (1,3) sensor units such as designated at 26 and 53 in FIG. 3, is simultaneously fed to each executable program 62 designated as “SensorHost1”, “SensorHost2” and “SensorHost3” respectively associated with the sensor units 26, 29 and 53 shown in FIG. 3. According to the specific operating state shown in FIG. 5, only the identified first and third sensor units will be responsive to the triggering signal, according to a common mode of operation that will be now described for the executable program “SensorHost1” 62 associated with the first sensor unit. Turning back to FIG. 4, the triggering signal sent by the trigger module 63 through data line 65 is received by the program “SensorHost” 62 through a first input 83 of application layer “SensorAppLayer” 79, which in turn generates at an output 91 a sample request signal toward the sensor data acquisition object “SensorObj” 81, in order to cause the latter to generate a sample as requested. Meanwhile, the sensor data acquisition object 81, upon receiving control calls at an input 88 from a controller module 52 that will be described below in detail, cumulates sensor data received at an input 90 as they are relayed by software component “DevicePlugin” 64 receiving at an input 92 sensor output signals from the sensor hardware component 66. This continuous data accumulation enables the sensor data acquisition object “SensorObj” 81 to be responsive to the sample request as it is received, by generating a current data sample that is sent to a second input 94 of the application layer “SensorAppLayer” 79, which data sample is then published at an output 96 through a data line 56 toward the controller module 52 for sensor data assembling and further processing, as will be described below in detail.

Turning back to FIG. 3, in an another embodiment, illustrated with truncated lines, the displacement of the object target area relative to the reference position can be calculated from an instantaneous speed value, combined with hardware-generated timing data in the form of a corresponding signal generated by a real timer module 76, such as Linux™ real-time, which signal is of very high accuracy. In that other embodiment, the trigger module 63 includes a software component 78 such as of plugin type, which is configured to receive at an input 80 the real timing signal in order to perform calculation (D=V/T) of the displacement of the object target area relative to the reference position D₀. In still another embodiment, also illustrated with truncated lines in FIG. 3, the displacement of the object target area relative to the reference position can be calculated from position profile information, such as provided by an encoder input/output interface 82 linked to the rotary encoder 28 coupled to conveyor 12 shown in FIG. 1, knowing the position displacement corresponding to each pulse generated by the rotary encoder 28. In that other embodiment, the trigger module 63 includes a software component 84 such as of plugin type, which is configured to receive at an input 86 the encoder pulse signal in order to perform calculation (D=number of pulses×distance/pulse) of the displacement of the object target area relative to the reference position D₀.

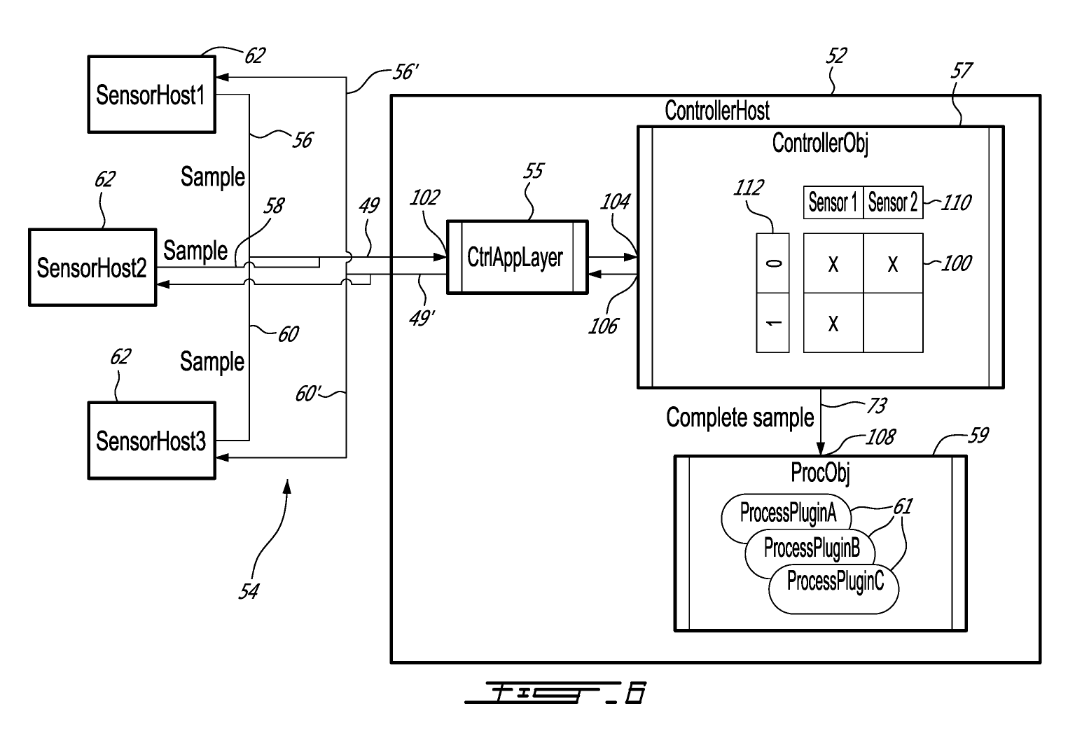

The sensor output data is sent to a controller module 52 though a main data line 49 also part of the data communication network 54, which controller module 52 is configured for assembling the sensor output data generated by all sensor units 26, 29 and 53 and associated with a same target area on the object, to achieve data synchronisation. In an embodiment, the controller module, implemented in the form of an executable program hosted by the computer 30 shown in FIG. 1, makes use of two linked software objects (e.g. programmed using C++/Corba), namely a control application layer 55 configured to receive at an input 102 the sensor output data as published, and a controller object 57 programmed to perform sensor output data assembling. Turning now to FIG. 6, to achieve their functions, the control application layer “CtrlAppLayer” 55 and controller object “CtrlObj” 57 are structured to implement an appropriate algorithm as will be now described in detail. In that embodiment, the control application layer “CtrlAppLayer” 55 is programmed to relay the sensor data to an input 104 of the controller object “CtrlObj” 57 as it is received. Data assembly as performed by the controller object “CtrlObj” 57 involves a data handling matrix 100 having a first dimension 110 associated with matrix columns, corresponding to the number of sensor units used, and a second dimension 112 associated with matrix lines, corresponding to a predetermined number of data sample sequences. It is to be understood that the specific association of first and second matrix dimensions with sensor units and sample sequences is arbitrary, and could be substituted. By way of the implemented algorithm, each cell of the matrix is assigned a data sample sequence identifier associated with one of the object target areas whenever a data sample is generated by an associated one of the triggered sensor units. Conveniently, the number of matrix lines corresponding to the predetermined number of sample sequences, is set to provide sufficient buffering capacity to complete a current data sample sequence handling, which is fed to an input 108 of the data processing software component “ProcObj” 59, while progressively handling the data samples of following sequences as they are generated, as will be explained in more detail below in the context of a practical example of handling matrix shown in Table 1 below, in view of FIG. 7.

A mentioned above, so as to enable the sensor units to be ready to generate output data as soon as a triggering signal is received, the controller object 57 is further programmed to control the starting of data acquisition of each sensor unit before being triggered, by means of a control signal generated at an output 106, which is relayed by control application layer “CtrlAppLayer” 55 to the executable program “SensorHost” 62 of each sensor unit through main data line 49′ and distribution lines 56′, 58′ and 60′ also part of the data communication network 54. For so doing, data acquisition may be controlled either in a discrete mode or in a continuous mode of operation. In the discrete mode, an object presence detector, such as a photocell, is provided at an infeed end of the conveyor at a location upstream of the sensor units, to sequentially sense the passage of a leading portion of the object being conveyed, and then sense the passage of its trailing end, causing the controller object 57 to send data acquisition starting/stopping control signals to the sensor units. In the continuous mode of operation, the controller object 57 is programmed to send a data acquisition starting control signal at the beginning of system operation.

Referring now to the example of FIG. 7, there is shown progressive displacement with time of portions of object 114, 214 each of sample length L=150 mm, moving in the direction of arrow 16 as it successively intersects the sensing fields of six sensor units disposed in spaced apart relationship along the travel path, e.g. separated by a predetermined distance d₁=100 mm in the example, at distances D₁ to D₆ from a reference position D₀ where a presence detector (e.g. photocell) is located, according to the discrete mode of operation as explained above. It is to be understood that a same position D₀ may be virtually established in a case where the continuous mode of data acquisition is implemented. In the present example, the following sensor units are provided: a NIR sensor (Chino) at D₁, an environmental air temperature and humidity sensor (Env) at D₂, an infrared temperature sensor (Temp) at D₃, a distance sensor (Distance) at D₄, a rotary encoder (Beltlength) at D₅, and a weight sensor (Weight) at D₆. As explained above, the photocell is provided at a location upstream of the first sensor unit (Chino), by a distance d₂=50 mm in the present example, wherein:

D₁=d₂

D₂=d₁ d₂

D₃=2d₁ d₂

D₄=3d₁ d₂

D₅=4d₁ d₂

D₆=5d₁ d₂

Turning now to Table 1 showing successive states of the handling matrix with time, it can be seen that the column order within the handling matrix need not be necessarily the same as the order according to which the sensor units are physically disposed along the travel path. In the present example, as indicated within parenthesis in FIG. 7 and in view of the handling matrix heading of Table 1, the sensors as located at D₁ D₂, D₃, D₄, D₅ and D₆ are respectively associated with columns C₂, C₄, C₅, C₃, C₁ and C₆ of the handling matrix.

A manner according to which data entry into the handling matrix is carried out progressively as each data sample is received by the application layer 55 of the controller module 52 and relayed to the controller object 57 at successive logging times, will now be explained with reference to FIG. 7 in view of Table 1.

```
TABLE 1
15:24:51.037150 - AquaCtrlObj- ---------------------------------------------------- AquaSensorChino - 30
15:24:51.041056-AquaCtrlObj- AquaSensorBeltLength, AquaSensorChino, AquaSensorDistance,
AquaSensorEnv, AquaSensorTemp, AquaSensorWeight
15:24:51.043986 - AquaCtrlObj - 0: -, 30, -, -, -, -
15:24:51.044962 - AquaCtrlObj - 1: -, -, -, -, -, -
15:24:51.046915 - AquaCtrlObj - 2: -, -, -, -, -, -
15:24:51.048868 - AquaCtrlObj - 3: -, -, -, -, -, -
15:24:51.050821 - AquaCtrlObj - 4: -, -, -, -, -, -
15:24:51.052775 - AquaCtrlObj - 5: -, -, -, -, -, -
15:24:51.056681 - AquaCtrlObj - 6: -, -, -, -, -, -
15:24:51.062540 - AquaCtrlObj - 7: -, -, -, -, -, -
15:24:51.065470 - AquaCtrlObj - 8: -, -, -, -, -, -
15:24:51.068400 - AquaCtrlObj - 9: -, -, -, -, -, -
15:24:51.074259-AquaCtrlObj - (non empty tuples) 0 vs 10 (token list size) (msg queue size = 0)
15:24:51.142618 - AquaCtrlObj- ---------------------------------------------------- AquaSensorEnv - 30
15:24:51.145548-AquaCtrlObj - AquaSensorBeltLength, AquaSensorChino, AquaSensorDistance,
AquaSensorEnv, AquaSensorTemp, AquaSensorWeight
15:24:51.149454 - AquaCtrlObj - 0: -, 30, -, 30, -, -
15:24:51.151407 - AquaCtrlObj - 1: -, -, -, -, -, -
15:24:51.157267 - AquaCtrlObj - 2: -, -, -, -, -, -
15:24:51.162150 - AquaCtrlObj - 3: -, -, -, -, -, -
15:24:51.167032 - AquaCtrlObj - 4: -, -, -, -, -, -
15:24:51.170939 - AquaCtrlObj - 5: -, -, -, -, -, -
15:24:51.173868 - AquaCtrlObj - 6: -, -, -, -, -, -
15:24:51.178751 - AquaCtrlObj - 7: -, -, -, -, -, -
15:24:51.185587 - AquaCtrlObj - 8: -, -, -, -, -, -
15:24:51.190470 - AquaCtrlObj - 9: -, -, -, -, -, -
15:24:51.193400-AquaCtrlObj - (non empty tuples) 0 vs 10 (token list size) (msg queue size = 1)
15:24:51.198282 - AquaCtrlObj- ---------------------------------------------------- AquaSensorChino - 31
15:24:51.201212-AquaCtrlObj - AquaSensorBeltLength, AquaSensorChino, AquaSensorDistance,
AquaSensorEnv, AquaSensorTemp, AquaSensorWeight
15:24:51.205118 - AquaCtrlObj - 0: -, 30, -, 30, -, -
15:24:51.210001 - AquaCtrlObj - 1: -, 31, -, -, -, -
15:24:51.214884 - AquaCtrlObj - 2: -, -, -, -, -, -
15:24:51.219767 - AquaCtrlObj - 3: -, -, -, -, -, -
15:24:51.225626 - AquaCtrlObj - 4: -, -, -, -, -, -
15:24:51.231486 - AquaCtrlObj - 5: -, -, -, -, -, -
15:24:51.239298 - AquaCtrlObj - 6: -, -, -, -, -, -
15:24:51.246134 - AquaCtrlObj - 7: -, -, -, -, -, -
15:24:51.250040 - AquaCtrlObj - 8: -, -, -, -, -, -
15:24:51.252970 - AquaCtrlObj - 9: -, -, -, -, -, -
15:24:51.256876-AquaCtrlObj - (non empty tuples) 0 vs 10 (token list size) (msg queue size = 1)
15:24:51.261759 - AquaCtrlObj- ---------------------------------------------------- AquaSensorTemp - 30
15:24:51.263712-AquaCtrlObj - AquaSensorBeltLength, AquaSensorChino, AquaSensorDistance,
AquaSensorEnv, AquaSensorTemp, AquaSensorWeight
15:24:51.266642 - AquaCtrlObj - 0: -, 30, -, 30, 30, -
15:24:51.269571 - AquaCtrlObj - 1: -, 31, -, -, -, -
15:24:51.274454 - AquaCtrlObj - 2: -, -, -, -, -, -
15:24:51.278361 - AquaCtrlObj - 3: -, -, -, -, -, -
15:24:51.286173 - AquaCtrlObj - 4: -, -, -, -, -, -
15:24:51.290079 - AquaCtrlObj - 5: -, -, -, -, -, -
15:24:51.293986 - AquaCtrlObj - 6: -, -, -, -, -, -
15:24:51.297892 - AquaCtrlObj - 7: -, -, -, -, -, -
15:24:51.300821 - AquaCtrlObj - 8: -, -, -, -, -, -
15:24:51.303751 - AquaCtrlObj - 9: -, -, -, -, -, -
15:24:51.311564-AquaCtrlObj - (non empty tuples) 0 vs 10 (token list size) (msg queue size = 1)
15:24:51.314493 - AquaCtrlObj- ---------------------------------------------------- AquaSensorEnv - 31
15:24:51.317423-AquaCtrlObj - AquaSensorBeltLength, AquaSensorChino, AquaSensorDistance,
AquaSensorEnv, AquaSensorTemp, AquaSensorWeight
15:24:51.320353 - AquaCtrlObj - 0: -, 30, -, 30, 30, -
15:24:51.323282 - AquaCtrlObj - 1: -, 31, -, 31, -, -
15:24:51.326212 - AquaCtrlObj - 2: -, -, -, -, -, -
15:24:51.330118 - AquaCtrlObj - 3: -, -, -, -, -, -
15:24:51.334025 - AquaCtrlObj - 4: -, -, -, -, -, -
15:24:51.341837 - AquaCtrlObj - 5: -, -, -, -, -, -
15:24:51.350626 - AquaCtrlObj - 6: -, -, -, -, -, -
15:24:51.355509 - AquaCtrlObj - 7: -, -, -, -, -, -
15:24:51.359415 - AquaCtrlObj - 8: -, -, -, -, -, -
15:24:51.363321 - AquaCtrlObj - 9: -, -, -, -, -, -
15:24:51.367228-AquaCtrlObj - (non empty tuples) 0 vs 10 (token list size) (msg queue size = 2)
15:24:51.371134 - AquaCtrlObj- ---------------------------------------------------- AquaSensorChino - 32
15:24:51.374064- quaCtrlObj - AquaSensorBeltLength, AquaSensorChino, AquaSensorDistance,
AquaSensorEnv, AquaSensorTemp, AquaSensorWeight
15:24:51.378946 - AquaCtrlObj - 0: -, 30, -, 30, 30, -
15:24:51.382853 - AquaCtrlObj - 1: -, 31, -, 31, -, -
15:24:51.388712 - AquaCtrlObj - 2: -, 32, -, -, -, -
15:24:51.395548 - AquaCtrlObj - 3: -, -, -, -, -, -
15:24:51.398478 - AquaCtrlObj - 4: -, -, -, -, -, -
15:24:51.402384 - AquaCtrlObj - 5: -, -, -, -, -, -
15:24:51.406290 - AquaCtrlObj - 6: -, -, -, -, -, -
15:24:51.411173 - AquaCtrlObj - 7: -, -, -, -, -, -
15:24:51.415079 - AquaCtrlObj - 8: -, -, -, -, -, -
15:24:51.419962 - AquaCtrlObj - 9: -, -, -, -, -, -
15:24:51.422892-AquaCtrlObj - (non empty tuples) 0 vs 10 (token list size) (msg queue size = 2)
15:24:51.426798-AquaCtrlObj- ---------------------------------------------------- AquaSensorDistance - 30
15:24:51.430704-AquaCtrlObj - AquaSensorBeltLength, AquaSensorChino, AquaSensorDistance,
AquaSensorEnv, AquaSensorTemp, AquaSensorWeight
15:24:51.435587 - AquaCtrlObj - 0: -, 30, 30, 30, 30, -
15:24:51.442423 - AquaCtrlObj - 1: -, 31, -, 31, -, -
15:24:51.449259 - AquaCtrlObj - 2: -, 32, -, -, -, -
15:24:51.456095 - AquaCtrlObj - 3: -, -, -, -, -, -
15:24:51.460001 - AquaCtrlObj - 4: -, -, -, -, -, -
15:24:51.465861 - AquaCtrlObj - 5: -, -, -, -, -, -
15:24:51.470743 - AquaCtrlObj - 6: -, -, -, -, -, -
15:24:51.473673 - AquaCtrlObj - 7: -, -, -, -, -, -
15:24:51.478556 - AquaCtrlObj - 8: -, -, -, -, -, -
15:24:51.481486 - AquaCtrlObj - 9: -, -, -, -, -, -
15:24:51.486368-AquaCtrlObj - (non empty tuples) 0 vs 10 (token list size) (msg queue size = 3)
15:24:51.493204 - AquaCtrlObj- ---------------------------------------------------- AquaSensorTemp - 31
15:24:51.499064-AquaCtrlObj - AquaSensorBeltLength, AquaSensorChino, AquaSensorDistance,
AquaSensorEnv, AquaSensorTemp, AquaSensorWeight
15:24:51.505900 - AquaCtrlObj - 0: -, 30, 30, 30, 30, -
15:24:51.511759 - AquaCtrlObj - 1: -, 31, -, 31, 31, -
15:24:51.515665 - AquaCtrlObj - 2: -, 32, -, -, -, -
15:24:51.519571 - AquaCtrlObj - 3: -, -, -, -, -, -
15:24:51.523478 - AquaCtrlObj - 4: -, -, -, -, -, -
15:24:51.530314 - AquaCtrlObj - 5: -, -, -, -, -, -
15:24:51.535196 - AquaCtrlObj - 6: -, -, -, -, -, -
15:24:51.543009 - AquaCtrlObj - 7: -, -, -, -, -, -
15:24:51.551798 - AquaCtrlObj - 8: -, -, -, -, -, -
15:24:51.556681 - AquaCtrlObj - 9: -, -, -, -, -, -
  15:24:51.560587-AquaCtrlObj - (non empty tuples) 0 vs 10 (token list size) (msg queue size = 6)
15:24:51.565470-AquaCtrlOb- -------------------------------------------------- AquaSensorBeltLength - 30
15:24:51.567423-AquaCtrlObj -AquaSensorBeltLength, AquaSensorChino, AquaSensorDistance,
AquaSensorEnv, AquaSensorTemp, AquaSensorWeight
15:24:51.570353 - AquaCtrlObj - 0: 30, 30, 30, 30, 30, -
15:24:51.574259 - AquaCtrlObj - 1: -, 31, -, 31, 31, -
15:24:51.578165 - AquaCtrlObj - 2: -, 32, -, -, -, -
15:24:51.581095 - AquaCtrlObj - 3: -, -, -, -, -, -
15:24:51.585978 - AquaCtrlObj - 4: -, -, -, -, -, -
15:24:51.593790 - AquaCtrlObj - 5: -, -, -, -, -, -
15:24:51.602579 - AquaCtrlObj - 6: -, -, -, -, -, -
15:24:51.605509 - AquaCtrlObj - 7: -, -, -, -, -, -
15:24:51.608439 - AquaCtrlObj - 8: -, -, -, -, -, -
15:24:51.610392 - AquaCtrlObj - 9: -, -, -, -, -, -
  15:24:51.612345-AquaCtrlObj (non empty tuples) 0 vs 10 (token list size) (msg queue size = 7)
15:24:51.615275 - AquaCtrlObj- ---------------------------------------------------- AquaSensorEnv - 32
15:24:51.618204-AquaCtrlObj - AquaSensorBeltLength, AquaSensorChino, AquaSensorDistance,
AquaSensorEnv, AquaSensorTemp, AquaSensorWeight
15:24:51.620157 - AquaCtrlObj - 0: 30, 30, 30, 30, 30, -
15:24:51.622111 - AquaCtrlObj - 1: -, 31, -, 31, 31, -
15:24:51.631876 - AquaCtrlObj - 2: -, 32, -, 32, -, -
15:24:51.634806 - AquaCtrlObj - 3: -, -, -, -, -, -
15:24:51.638712 - AquaCtrlObj - 4: -, -, -, -, -, -
15:24:51.641642 - AquaCtrlObj - 5: -, -, -, -, -, -
15:24:51.648478 - AquaCtrlObj - 6: -, -, -, -, -, -
15:24:51.651407 - AquaCtrlObj - 7: -, -, -, -, -, -
15:24:51.654337 - AquaCtrlObj - 8: -, -, -, -, -, -
15:24:51.658243 - AquaCtrlObj - 9: -, -, -, -, -, -
15:24:51.663126-AquaCtrlObj -(non empty tuples) 0 vs 10 (token list size) (msg queue size = 8)
  15:24:51.666056 - AquaCtrlObj- ---------------------------------------------------- AquaSensorChino - 33
  15:24:51.668986-AquaCtrlObj-AquaSensorBeltLength, AquaSensorChino, AquaSensorDistance,
AquaSensorEnv, AquaSensorTemp, AquaSensorWeight
15:24:51.671915 - AquaCtrlObj - 0: 30, 30, 30, 30, 30, -
15:24:51.673868 - AquaCtrlObj - 1: -, 31, -, 31, 31, -
15:24:51.676798 - AquaCtrlObj - 2: -, 32, -, 32, -, -
15:24:51.678751 - AquaCtrlObj - 3: -, 33, -, -, -, -
15:24:51.681681 - AquaCtrlObj - 4: -, -, -, -, -, -
15:24:51.683634 - AquaCtrlObj - 5: -, -, -, -, -, -
15:24:51.687540 - AquaCtrlObj - 6: -, -, -, -, -, -
15:24:51.689493 - AquaCtrlObj - 7: -, -, -, -, -, -
15:24:51.692423 - AquaCtrlObj - 8: -, -, -, -, -, -
15:24:51.697306 - AquaCtrlObj - 9: -, -, -, -, -, -
15:24:51.702189-AquaCtrlObj -((non empty tuples) 0 vs 10 (token list size) (msg queue size = 8)
15:24:51.706095-AquaCtrlObj- ---------------------------------------------------- AquaSensorDistance - 31
  15:24:51.709025-AquaCtrlObj-AquaSensorBeltLength, AquaSensorChino, AquaSensorDistance,
AquaSensorEnv, AquaSensorTemp, AquaSensorWeight
15:24:51.711954 - AquaCtrlObj - 0: 30, 30, 30, 30, 30, -
15:24:51.714884 - AquaCtrlObj - 1: -, 31, 31, 31, 31, -
15:24:51.717814 - AquaCtrlObj - 2: -, 32, -, 32, -, -
15:24:51.720743 - AquaCtrlObj - 3: -, 33, -, -, -, -
15:24:51.723673 - AquaCtrlObj - 4: -, -, -, -, -, -
15:24:51.726603 - AquaCtrlObj - 5: -, -, -, -, -, -
15:24:51.729532 - AquaCtrlObj - 6: -, -, -, -, -, -
15:24:51.732462 - AquaCtrlObj - 7: -, -, -, -, -, -
15:24:51.736368 - AquaCtrlObj - 8: -, -, -, -, -, -
15:24:51.739298 - AquaCtrlObj - 9: -, -, -, -, -, -
15:24:51.742228-AquaCtrlObj - (non empty tuples) 0 vs 10 (token list size) (msg queue size = 8)
15:24:51.747111 - AquaCtrlObj- ---------------------------------------------------- AquaSensorTemp - 32
15:24:51.751017 - AquaCtrlObj - AquaSensorBeltLength, AquaSensorChino,
AquaSensorDistance, AquaSensorEnv, AquaSensorTemp, AquaSensorWeight
15:24:51.752970 - AquaCtrlObj - 0: 30, 30, 30, 30, 30, -
15:24:51.755900 - AquaCtrlObj - 1: -, 31, 31, 31, 31, -
15:24:51.758829 - AquaCtrlObj - 2: -, 32, -, 32, 32, -
15:24:51.761759 - AquaCtrlObj - 3: -, 33, -, -, -, -
15:24:51.762736 - AquaCtrlObj - 4: -, -, -, -, -, -
15:24:51.764689 - AquaCtrlObj - 5: -, -, -, -, -, -
15:24:51.767618 - AquaCtrlObj - 6: -, -, -, -, -, -
15:24:51.769571 - AquaCtrlObj - 7: -, -, -, -, -, -
15:24:51.771525 - AquaCtrlObj - 8: -, -, -, -, -, -
15:24:51.774454 - AquaCtrlObj - 9: -, -, -, -, -, -
15:24:51.781290-AquaCtrlObj - (non empty tuples) 0 vs 10 (token list size) (msg queue size = 9)
15:24:51.787150 - AquaCtrlObj- ---------------------------------------------------- AquaSensorWeight - 30
15:24:51.792032-AquaCtrlObj - AquaSensorBeltLength, AquaSensorChino, AquaSensorDistance,
AquaSensorEnv, AquaSensorTemp, AquaSensorWeight
15:24:51.797892 - AquaCtrlObj - 0: 30, 30, 30, 30, 30, 30
15:24:51.805704 - AquaCtrlObj - 1: -, 31, 31, 31, 31, -
15:24:51.810587 - AquaCtrlObj - 2: -, 32, -, 32, 32, -
15:24:51.814493 - AquaCtrlObj - 3: -, 33, -, -, -, -
15:24:51.821329 - AquaCtrlObj - 4: -, -, -, -, -, -
15:24:51.829142 - AquaCtrlObj - 5: -, -, -, -, -, -
15:24:51.836954 - AquaCtrlObj - 6: -, -, -, -, -, -
15:24:51.842814 - AquaCtrlObj - 7: -, -, -, -, -, -
15:24:51.851603 - AquaCtrlObj - 8: -, -, -, -, -, -
15:24:51.866251 - AquaCtrlObj - 9: -, -, -, -, -, -
15:24:51.873087-AquaCtrlObj -(non empty tuples) 0 vs 10 (token list size) (msg queue size = 12)
15:24:51.889689-AquaCtrlObj----------------------------------------------------- AquaSensorBeltLength- 31
15:24:51.896525-AquaCtrlObj_i::svc-MATCH(AquaCtrlObj)-sampleNumber=30,pieceNumber=30
15:24:51.912150-AquaCtrlObj -AquaSensorBeltLength, AquaSensorChino, AquaSensorDistance,
AquaSensorEnv, AquaSensorTemp, AquaSensorWeight
15:24:51.919962 - AquaCtrlObj - 0: -, -, -, -, -, -
15:24:51.938517 - AquaCtrlObj - 1: 31, 31, 31, 31, 31, -
15:24:51.942423 - AquaCtrlObj - 2: -, 32, -, 32, 32, -
15:24:51.946329 - AquaCtrlObj - 3: -, 33, -, -, -, -
15:24:51.951212 - AquaCtrlObj - 4: -, -, -, -, -, -
15:24:51.953165 - AquaCtrlObj - 5: -, -, -, -, -, -
15:24:51.956095 - AquaCtrlObj - 6: -, -, -, -, -, -
15:24:51.961954 - AquaCtrlObj - 7: -, -, -, -, -, -
15:24:51.965861 - AquaCtrlObj - 8: -, -, -, -, -, -
15:24:51.973673 - AquaCtrlObj - 9: -, -, -, -, -, -
```

As shown in Table 1, the first dimension associated with columns of the data handling matrix is set to “6” to correspond to the number of sensor units used, and the dimension associated with matrix lines, corresponding to a predetermined number of data sample sequences, is conveniently set to “10” (0-9), enabling progressive handling of 10 sample sequences. Table 1 illustrates successive status changes that occur as new data samples are received at given logging times by the controller object, which in turn enters a corresponding sample sequence identifier in the matrix cell corresponding to the current matrix line and matrix column associated with the sensor unit having generated each new data sample. Turning back to FIG. 4, it can be appreciated that the communication of the triggering signal from the trigger module 63 to the executable program “SensorHost” 62, and then from the latter to the controller 52, implies a communication time, which adds to the sensor sample generating time. Therefore the logging time associated with a given data sample is delayed with respect to the time at which the triggering signal is generated by the trigger module. However, for all practical purposes, the cumulative communication and sample generation time being of a very short length, such delay does not adversely affect data assembling performance.

Turning back to FIG. 7, at a triggering time TT₀ when a first portion of object 114 reaches the sensing field of the photocell located at D₀, the data handling matrix is empty, and data acquisition of each sensor unit is started before being triggered as explained above. Just after a triggering signal identifying the sensor (Chino) located at D₁ is generated at TT₁ and as soon as a first data sample is received at logging time 51.043986, the identifier of the first data sample sequence, which is “30” in the present example and is associated with a target area of the object portion 114, is entered in line L₀, column C₂ of the matrix. Then, just after a triggering signal identifying the sensor (Env) located at D₂ is generated at TT₂ and as soon as a second data sample is received at logging time 51.149454, the identifier “30” of the first data sample sequence is entered in line L₀, column C₄ of the matrix. Then, before the sensor (Temp) located at D₃ is triggered, the sensor (Chino) located at D₁ is triggered again at TT₃, another data sample is received at logging time 51.210001 in relation with a target area of a following portion of object 214, and the identifier of a second data sample sequence “31” is entered in line L₁, column C₂ of the matrix. Then, in relation with the first data sample sequence and the target area of object portion 114, the sensor (Temp) located at D₃ is triggered at TT₄, a data sample is received at logging time 51.266642 and the identifier “30” is entered in line L₀, column C₄ of the matrix. Then, before the sensor (Distance) located at D₄ is triggered, the sensor (Env) located at D₂ which is triggered again at TT₅, another data sample is received at logging time 51.323282 in relation with the target area of the following object portion 214, and the identifier of the second data sample sequence “31” is entered in line L₁, column C₄ of the matrix. Then, the sensor (Chino) located at D₁ and the sensor (Distance) located at D₄ are simultaneously triggered at TT₆ in relation with two distinct data sample sequences and target areas. Due to different cumulative communication and sample generation time lengths required for receiving the two data samples, just before a data sample from the sensor (Distance) located at D₄ is received at logging time 51.435587, another data sample is received from the sensor (Chino) located at D₁ at logging time 51.388712 in relation with a target area of another following portion of object 314, and the identifier of a third data sample sequence “32” is entered in line L₂, column C₂ of the matrix. Thereafter, in relation with the first data sample sequence and the target area of object portion 114, the data sample from the sensor (Distance) located at D₃ is received at logging time 51.435587 as mentioned above, and the identifier “30” is entered in line L₀, column C₃ of the matrix. Then, before the sensor (Beltlength) located at D₅ is triggered, the sensor (Temp) located at D₃ is triggered at time TT₇, another data sample is received fat logging time 51.511759 in relation with the target area of following object portion 214, and the identifier of the second data sample sequence “31” is entered in line L₁, column C₅ of the matrix. Then, the sensor (Beltlength) located at D₅ and the sensor (Env) located at D₂ are simultaneously triggered at TT₈ in relation with two distinct data sample sequences and target areas. In relation with the first data sample sequence and the target area of object portion 114, a data sample is received from the sensor (Beltlength) located at D₅ at logging time 51.570353, and the identifier “30” is entered in line L₀, column C₁ of the matrix. Thereafter, another data sample is received from the sensor (Env) located at D₂ at logging time 51.631876 in relation with the target area of the other following object portion 314, and the identifier of the third data sample sequence “32” is entered in line L₂, column C₄ of the matrix. Then, the sensor (Chino) located at D₁ and the sensor (Distance) located at D₄ are simultaneously triggered at TT₉ in relation with two distinct data sample sequences and target areas. Another data sample is received from the sensor (Chino) located at D₁ at logging time 51.678751 in relation with a target area of another following portion of object 414, and the identifier of a fourth data sample sequence “33” is entered in line L₃, column C₂ of the matrix. Thereafter, another data sample is received from the sensor (Distance) located at D₄ at logging time 51.714884 in relation with the target area of the following object portion 214, and the identifier of the second data sample sequence “31” is entered in line L₁, column C₃ of the matrix. Then, the sensor (Temp) located at D₃ and the sensor (Weight) located at D₆ are simultaneously triggered at TT₁₀ in relation with two distinct data sample sequences and target areas. Another data sample is received from the sensor (Temp) located at D₃ at logging time 51.758829 in relation with the target area of the other following object portion 314, and the identifier of the third data sample sequence “32” is entered in line L₂, column C₅ of the matrix. Thereafter, to terminate data handling in relation with the first data sample sequence “30”, a last data sample is received from the sensor (Weight) located at D₆ at logging time 51.797892 in relation with the target area of the object portion 114, and a last identifier “30” is entered in line L₀, column C₆ of the matrix. The data handling related to the first data sample sequence being ended, this means that each data sample of the current sequence “30” has been received by the application layer 55 of the controller module 52 shown in FIG. 3, enabling the controller to gather the sensor data samples to generate assembled sensor data. Turning back to Table 1, it can be seen that identifier data corresponding to the completed sample data sequence “30” has been deleted at logging time 51.919962, in order to leave room in the matrix for next data to be entered.

In an embodiment as shown in FIG. 6, the assembled sensor data in the form of a complete sample sequence is transferred through data line 73 to a data processing software component 59 also included in the controller module 52 and configured to perform predetermined sequences of data processing aimed at generating measurement data (e.g. calibrated moisture, dry weight, dry density), making use of software components 61, such as of plugin type designated by “ProcessPluginA”, “ProcessPluginB” and “ProcessPluginC”, each being specifically programmed to perform a processing task involved by a given sequence. Optionally, as shown in the embodiment of FIG. 3, so as to distribute processing capacity, specific software components 61′ may be called by one or more data processing software component 59′ included in one or more separate executable program modules 68, 68′ hosted by one or more further computers linked to the controller object 57 through data lines 71, 71′. Optionally, a processing sequence may be performed locally by the processor integrated in a sensor unit, e.g. in cases where a large amount of data is involved, so as to generate locally-processed output sensor data, provided synchronisation of the raw data involved by the processing tasks has been first performed by the controller object 57 as described above.

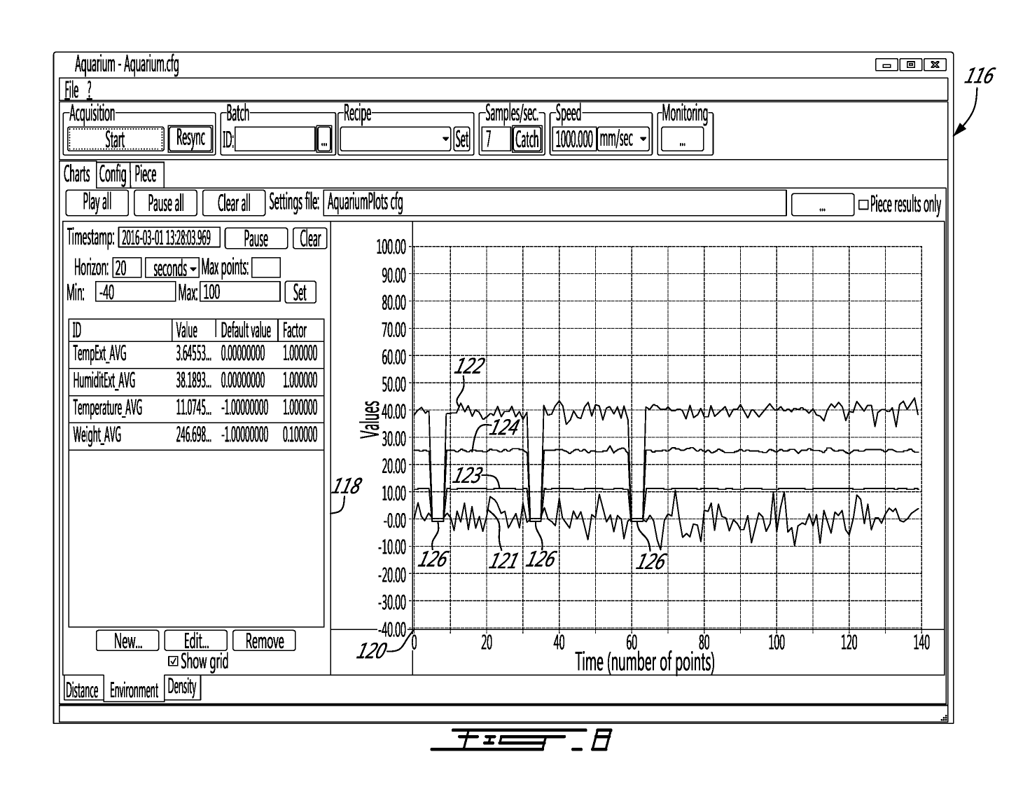

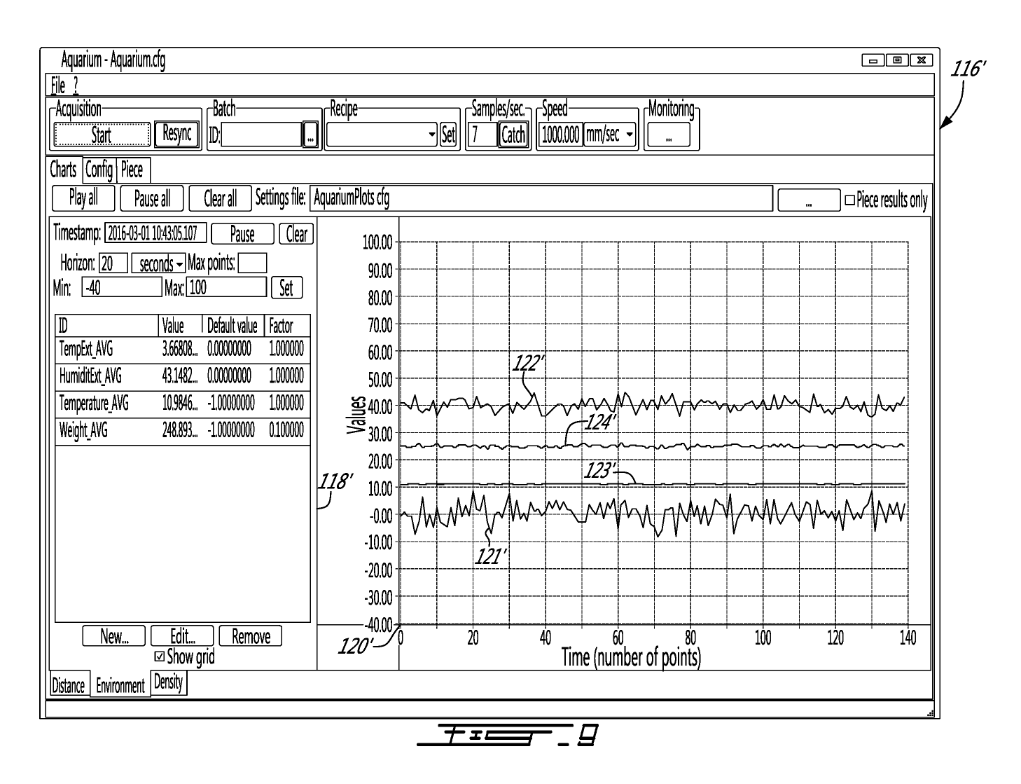

Conveniently, the controller module 52 may be linked to an operator interface 75 via a data line 77 provided by the communication network, for measurement displaying purposes, and to allow an operator to configure the system's functions. An example of displayed screenshot generated by such operator interface is shown in FIG. 8 as the measurement system described above in view of FIG. 1 is performing data acquisition in a discrete mode of operation to inspect objects transported on the system conveyor. According to the example screenshot 116 of FIG. 8, the system is in a data acquisition status using a processing parameter setting as selected by the user, to measure and display mean values of environmental temperature designated as “TempExt_AVG”, environmental humidity designated as “HumiditExt_AVG”, object temperature designated as “Temperature_AVG” and weight designated as “Weight_AVG”, as identified in the selected window 118. The evolution with time of all measured parameters is shown (using appropriate scale factor) in a graph window 120, wherein data curves 121 and 122 represent mean environmental temperature and humidity values, whereas data curves 123 and 124 represent mean object temperature and weight values. In this example, the data display horizon being set to 20 second with data catch rate of 7 samples/s and conveying speed of 1000 mm/s, a total of 140 measurement points are movably displayed as data generation is performed with time, so that currently generated data that appear at point 140 are progressively shifted from right to left, to disappear from the display screen after 20 second. As described above, as the leading end and trailing end of each inspected object respectively enter and leave the sensing field of the presence detector, data acquisition is sequentially started and stopped in response to the control signals sent to the triggered sensor units. Conveniently, during the time gaps indicated at 126 separating two successive data signal generation sequences, a default value is assigned to each parameter for displaying purposes. Turning now to FIG. 9, there is shown another example of screenshot 116′ taken while data acquisition is performed for the same parameters as involved in the previous example, but here in a continuous mode of operation to inspect bulk material transported on the system conveyor. Here again, the evolution with time of all measured parameters is shown in a graph window 120′, wherein data curves 121′ and 122′ represent mean environmental temperature and humidity values, whereas data curves 123′ and 124′ represent mean material temperature and weight values. Here again, the data display horizon being set to 20 second with data catch rate of 7 samples/s and conveying speed of 1000 mm/s, a total of 140 measurement points are movably displayed as data generation is performed with time.

1. A system for controlling generation of data by a plurality of sensor units, said data being related to a target area on an object moving at a known speed or position profile along a travel path intersecting a sensing field associated with each said sensor unit located at a known distance from a reference position on the travel path, comprising:
a data communication network linked to the sensor units;
a trigger module linked to said communication network and configured for calculating from the speed or position profile a displacement of the object target area relative to the reference position, to generate a sensor triggering signal specific to each sensor unit as soon as the displacement corresponds to the associated sensor unit distance, said sensor triggering signal causing the sensor unit to generate output data; and
a controller module linked to said communication network and configured for assembling the sensor output data generated by said sensor units and associated with the object target area.

2. The system according to claim 1, wherein the displacement of the object target area relative to the reference position is calculated from said speed using one of a software-generated timing signal and a hardware-generated timing signal received by said trigger module.

3. The system according to claim 1, wherein the displacement of the object target area relative to the reference position is calculated from said position profile in the form of a displacement-related pulse signal received by said trigger module.

4. The system according to claim 1, wherein said trigger module is further configured to control starting of data acquisition by each said sensor unit before triggering thereof.

5. The system according to claim 1, wherein the output sensor data generated by said sensor units are assembled by said controller module into a sequence of data samples related to said object target area.

6. The system according to claim 5, wherein the generated sensor triggering signal provides identification of said data sample sequence and identification of said sensor unit to be triggered.

7. A method for controlling generation of data by a plurality of sensor units, said data being related to a target area on an object moving at a known speed or position profile along a travel path intersecting a sensing field associated with each said sensor unit located at a known distance from a reference position on the travel path, comprising the steps of:
i) calculating from the speed or position profile a displacement of the object target area relative to the reference position, and generating from said calculated displacement a sensor triggering signal specific to each sensor unit as soon as the displacement correspond to the associated sensor unit distance, said sensor triggering signal causing the sensor unit to generate output data; and
ii) assembling the sensor output data generated by said sensor units and associated with the object target area.

8. The method according to claim 7, wherein the displacement of the object target area relative to the reference position is calculated from said speed using one of software-generated timing data and hardware-generated timing data.

9. The method according to claim 7, wherein the sensor output data generated by said sensor units are assembled into a sequence of data samples related to said object target area.

10. The method according to claim 9, wherein the generated sensor triggering signal provides identification of said data sample sequence and identification of said sensor unit to be triggered.

11. The method according to claim 7, wherein said data of which generation is controlled are further related to a plurality of further target areas on said object, said calculating step i) being further performed for each said further target area to generate a further sensor triggering signal specific to each sensor unit and causing thereof to generate further output data, said assembling step ii) being performed for the further output data generated by said sensor units and associated with each said further object target area, said further output data being assembled into a sequence of data samples related to each said further object target area.

12. The method according to claim 11, wherein said assembling step ii) is performed using a data handling matrix having a first dimension corresponding to the number of said sensor units and a second dimension corresponding to a predetermined number of logging times of said generated output data, each cell of said matrix being assigned a sample sequence identifier associated with one of said object target areas whenever a data sample is generated by an associated one of said sensor units.

13. A non-transitory software product data recording medium in which program code is stored causing a computer to perform method steps for controlling generation of data by a plurality of sensor units, said data being related to a target area on an object moving at a known speed or position profile along a travel path intersecting a sensing field associated with each said sensor unit located at a known distance from a reference position on the travel path, said method steps comprising:
i) calculating from the speed or position profile a displacement of the object target area relative to the reference position, and generating from said calculated displacement a sensor triggering signal specific to each sensor unit as soon as the displacement correspond to the associated sensor unit distance, said sensor triggering signal causing the sensor unit to generate output data; and
ii) assembling the sensor output data generated by said sensor units and associated with the object target area.

14. The software product data recording medium according to claim 13, wherein the displacement of the object target area relative to the reference position is calculated from said speed using one of software-generated timing data and hardware-generated timing data.

15. The software product data recording medium according to claim 13, wherein the sensor output data generated by said sensor units are assembled into a sequence of data samples related to said object target area.

16. The software product data recording medium according to claim 15, wherein the generated sensor triggering signal provides identification of said data sample sequence and identification of said sensor unit to be triggered.

17. The software product data recording medium according to claim 13, wherein said data of which generation is controlled are further related to a plurality of further target areas on said object, said calculating step i) being further performed for each said further target area to generate a further sensor triggering signal specific to each sensor unit and causing thereof to generate further output data, said assembling step ii) being performed for the further output data generated by said sensor units and associated with each said further object target area, said further output data being assembled into a sequence of data samples related to each said further object target area.

18. The method according to claim 17, wherein said assembling step ii) is performed using a data handling matrix having a first dimension corresponding to the number of said sensor units and a second dimension corresponding to a predetermined number of logging times of said generated output data, each cell of said matrix being assigned a sample sequence identifier associated with one of said object target areas whenever a data sample is generated by an associated one of said sensor units.
